(19) United States
(12) Patent Application Publication
(10) Pub. No.: US 2016/0290550 A1
(43) Pub. Date: Oct. 6, 2016

(54) THERMALLY INSULATED TUBULAR

(71) Applicant: SHAWCOR LTD., Toronto (CA)

(72) Inventors: Sanjay SHAH, Toronto (CA); Afolabi LOWRIE, Toronto (CA); Eugene ALYMOV, Toronto (CA); Madhusudan V. DESAI, Toronto (CA)

(73) Assignee: SHAWCOR LTD., Toronto (CA)

(21) Appl. No.: 15/035,144

(22) PCT Filed: Nov. 7, 2014
(86) PCT No.: PCT/CA2014/051076

§ 371 Date: May 6, 2016

Related U.S. Application Data
(60) Provisional application No. 61/901,513, filed on Nov. 8, 2013.

(51) Int. Cl. F16L 59/147; B32B 27/08; B32B 1/08

(52) U.S. Cl. CPC F16L 59/147; B32B 1/08; B32B 27/08; B32B 2307/30; B32B 2307/304; B32B 2307/558; B32B 2597/00

(57) ABSTRACT

A thermally insulated tubular made up of a first pipe having a first pipe diameter and a second pipe having a second pipe diameter. The second pipe diameter is greater than the first pipe diameter. The first pipe positioned along a conduit of the second pipe and spaced-apart from an interior surface of the first pipe. A thermally insulating composition coupling the first pipe to the second pipe and positioned in an annulus formed by the first and second pipe. The thermally insulating composition containing a thermally insulating or thermal shock resistant layer and a thermally insulating concrete composition.

### CROSS-REFERENCE TO RELATED APPLICATIONS

This application claims the benefit of and priority to U.S. Provisional Patent Application No. 61/901,513 filed Nov. 8, 2013, under the title THERMAL INSULATING CONCRETE COMPOSITION. The content of the above patent application is hereby expressly incorporated by reference into the detailed description hereof.

### FIELD

The specification relates to thermally insulated tubular having a thermal insulating concrete composition.

### BACKGROUND

In the petroleum industry, injection and production tubings are used within a borehole for injecting steam into the borehole and for producing oil from subsurface bearing formations to the surface, respectively. This tubing is comprised of elongate sections threaded together to form the injection and production strings.

Downhole tubing must operate in a harsh thermal, mechanical and chemical environment. The tubing and any coating, if applied, on the tubing can be exposed to aromatic organic compounds and steam at very high temperatures (example 200-300° C.) and at high pressures. Also, where the downhole tubing is assembled by screwing together threaded pipe sections, substantial forces may be exerted on the pipe and any exterior coating on the pipe during assembly of the pipe string. All these factors can limit the type of coating that can be applied to the tubing.

During production operations, pipe clogging solids can become an issue if hot hydrocarbons are allowed to cool as they flow out of hydrocarbon reservoirs. Specifically, as temperature decreases, the flow through pipelines can be impeded by high viscosity and wax formation in liquid products such as tar/bitumen, and by hydrate formation in products such as natural gas. This can also result in significantly reduced internal flow diameters of production piping and well productivity.

These problems can be reduced by using vacuum insulated pipelines, but such insulated pipelines can be expensive and also limited in terms of the size. In addition, although vacuum insulated pipelines can be used for temperature control of steam injection lines, due to potential loss of vacuum and long term weld integrity, they can pose as an unattractive option.

Accordingly, there is a need in the art to provide an effective thermal insulation material for the external/internal coating of pipes used for downhole tubing. Further, there is a need in the art for a thermal insulation coating having sufficient strength and compressibility to withstand the rough handling of pipe normally associated with the production process of hydrocarbons. Moreover, there is a need in the art for a process for application of such a coating on pipes used in downhole tubing.

### SUMMARY OF THE INVENTION

In one aspect, the specification relates to a thermally insulated tubular, comprising:
a first pipe having a first pipe diameter and a second pipe having a second pipe diameter, the second pipe diameter being greater than the first pipe diameter, the first pipe positioned along a conduit of the second pipe and spaced-apart from an interior surface of the first pipe; and
a thermally insulating composition coupling the first pipe to the second pipe and positioned in an annulus formed by the first and second pipe, the thermally insulating composition comprising:
a thermally insulating or thermal shock resistant layer, or a combination thereof; and
a thermally insulating concrete composition.

In one embodiment, the thermally insulating or thermal shock resistant layer is an aerogel blanket. In another embodiment, the thermally insulating or thermal shock resistant layer is an alkali-resistant fiberglass cloth that can also help to avoid strong bonding between the steel surface and the thermally insulating concrete.

In another aspect, the specification discloses a process for manufacturing a thermally insulated tubular, the process comprising the steps of:
coupling a thermally insulating or thermal shock resistant layer to an exterior surface of a first pipe;
positioning the first pipe with the thermally insulating or thermal shock resistant layer, or a combination thereof, along a conduit of a second pipe, the exterior surface of the first pipe being spaced apart from the interior surface of the second pipe; and
injecting a thermally insulating concrete composition in the annulus formed between the exterior surface of the first pipe and the interior surface of the second pipe.

In another still further aspect, the specification discloses a process for extracting hydrocarbon using the tubular, as disclosed herein.

### BRIEF DESCRIPTION OF THE DRAWINGS

Reference will now be made, by way of example, to the accompanying drawings which show example embodiments of the present application, and in which:

FIG. 1 is a perspective view of an end of a pipe in accordance with one aspect of the specification;

FIG. 2 is an end view of a pipe in accordance with one aspect of the specification;

FIG. 3 is a cross-sectional side view of a pipe in accordance with one aspect of the specification;

FIG. 4 is a cross-sectional view, along the line A-A of a pipe in accordance with one aspect of the specification;

FIG. 5 is a cross-sectional view of a pipe coupled to a second pipe in accordance with one aspect of the specification;

FIG. 6 is an enlarged cross-sectional view of a pipe coupled to a second pipe using a coupler in accordance with one aspect of the specification;

FIG. 7 discloses a table containing summary of some of the compositions prepared and their properties.

Similar reference numerals may have been used in different figures to denote similar components.

### DESCRIPTION

As noted above, in one aspect, the specification relates to a thermally insulated tubular, comprising:
a first pipe having a first pipe diameter and a second pipe having a second pipe diameter, the second pipe diameter being greater than the first pipe diameter, the first pipe positioned along a conduit of the second pipe and spaced-apart from an interior surface of the first pipe; and
a thermally insulating composition coupling the first pipe to the second pipe and positioned in an annulus formed by the first and second pipe, the thermally insulating composition comprising:
a thermally insulating or thermal shock resistant layer; and
a thermally insulating concrete composition.

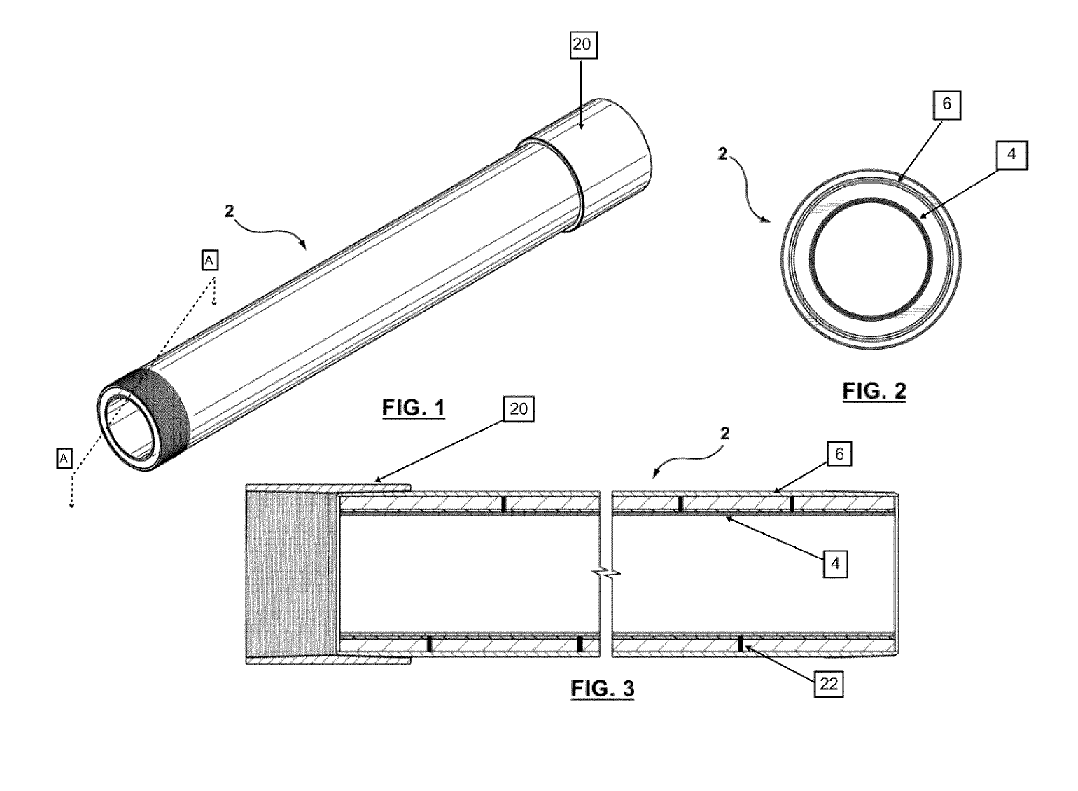

FIGS. 1 and 2 shows an embodiment of a tubular (2) in accordance with one aspect of the invention. The tubular (2) can be used, for example and without limitation, in the petroleum industry for injecting steam into the borehole and/or for the extraction of crude oil from the subsurface bearing formations to the surface. The tubular (2) disclosed herein can provide insulation, which can help to maintain the temperature of steam injected into the borehole or by helping to prevent cooling of crude oil retrieved from the subsurface. In one embodiment, the tubular (2) disclosed herein can help to improve the thermal efficiency of the process by as much as 50%. Hence, the current invention can provide a high temperature (stable and usable up to at least 305° C.) thermally insulated tubular.

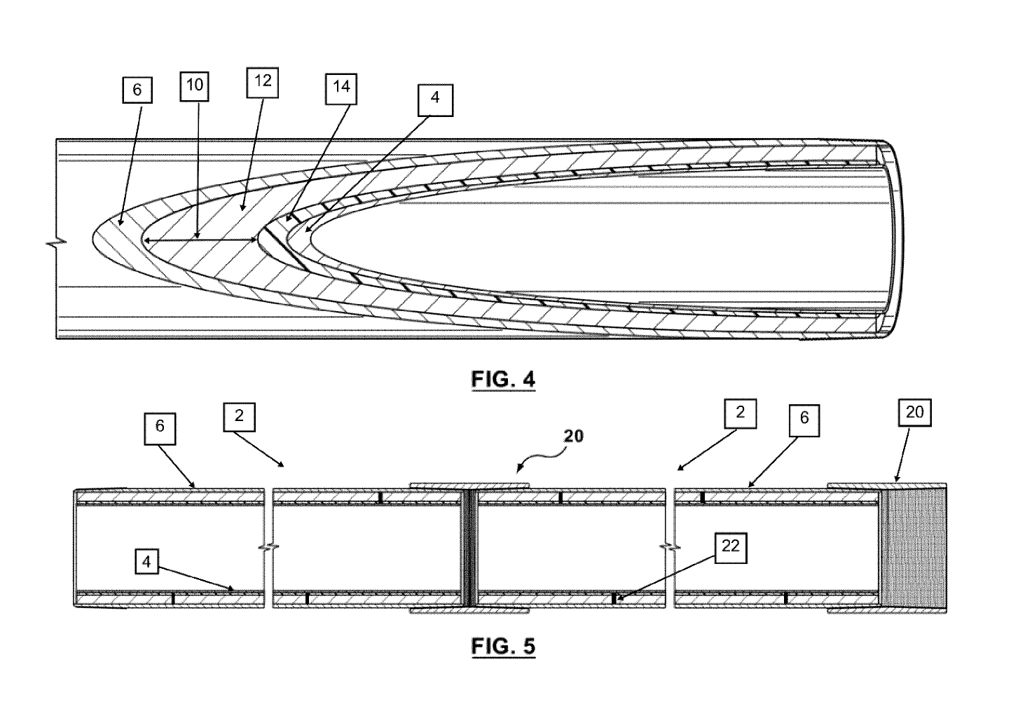

FIGS. 2 to 6 show an end view and sectional views of the tubular (2). The tubular (2) contains a first hollow pipe (4) and a second hollow pipe (6). In accordance with the invention, the tubular (2) is a pipe-in-pipe system, where the first hollow pipe (4) is an inner pipe and the second hollow pipe (6) is an outer pipe. Moreover, the first pipe (4) has a diameter that is less than the diameter of the second pipe (6).

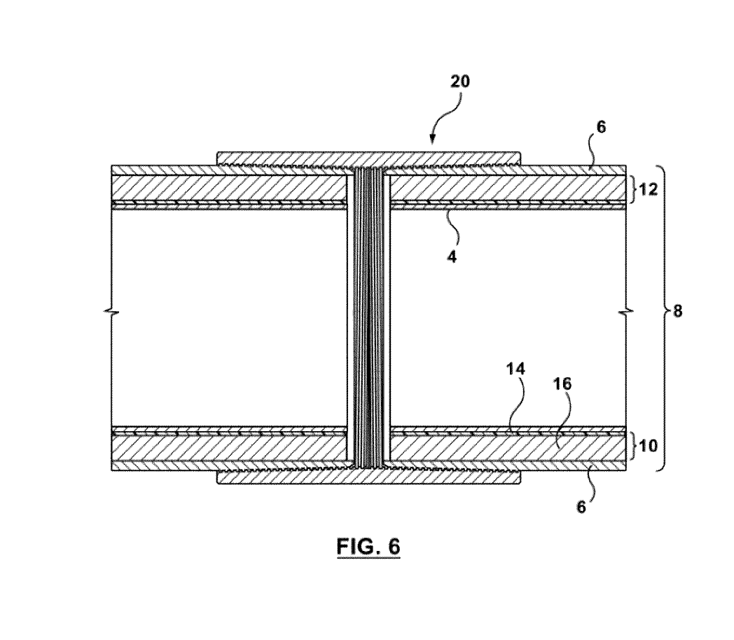

The pipes used in accordance with the invention are not particularly limited and should be known to a person of ordinary skill in the art. Moreover, the dimensions and other features of the pipe can depend upon the particular application requirements. In one embodiment, for example and without limitation, the first pipe (4) is shorter in length than the second pipe (FIG. 3). Moreover, as can be ascertained from FIGS. 3 and 6, the first pipe (4) is positioned so that the ends of the second pipe (6) extend beyond the ends of the first pipe (4). This provides allowance for thermal expansion of the inner pipe (4), which is more closely in contact with the hot fluid.

As noted above, the first pipe (4) is positioned internally along the conduit (8) of the second pipe (6). The first pipe (4) is also spaced apart from an internal surface of the second pipe (6). The spacing apart of the first pipe (4) from an internal surface of the second pipe (6) results in formation of an annulus (10) between the first pipe (4) and the second pipe (6).

The means and method to space-apart the first pipe (4) from the second pipe (6) are not particularly limited. In one embodiment, for example and without limitation, centralizers are provided on the outer surface of the first pipe (4). In a particular embodiment, the centralizer is formed by tabs (22) that are coupled, for example and without limitation, by welding to the outer surface of the first pipe (4). The dimensions of the tabs (22) are sufficient to create a space between the outer surface of the first pipe (4) and the inner surface of the second pipe (6). The tabs (22) extend sufficiently from the outer surface of the first pipe (4) to prevent contact of the outer surface of the first pipe (4) from the inner surface of the second pipe (6), while also avoiding damaging the inner surface of the second pipe (6) or preventing the first pipe (4) to be positioned along the length of the second pipe (6). In a further embodiment, a number of centralizers (22) are provided on the outer surface of the first pipe (4) to maintain the dimension of the annulus along the length of the tubular (2).

The dimension of the annulus (10) is not particularly limited and can depend upon the application requirements. In accordance with the invention, the size of the annulus (10) is sufficient to accommodate a thermally insulating composition (12) within the annulus (10). In one embodiment, for example and without limitation, the distance between the outer surface of the first pipe (4) and the inner surface of the second pipe (6) is at least about 0.5, 1, 2 or 3 inches. In another embodiment, the distance between the outer surface of the first pipe (4) and the inner surface of the second pipe (6) ranges from 0.5 to 5 inches, and any value in between.

In accordance with the invention, the thermally insulating composition (12) contains a thermally insulating or thermal shock resistant layer (14), or a combination thereof, and a thermally insulating concrete composition (16). The thermally insulating layer (14) provides thermal insulation and a thermal shock resistant layer provides thermal shock resistance. Thermal shock occurs when a thermal gradient causes different parts of an object to expand by different amounts. This differential expansion can be understood in terms of stress or of strain, equivalently. At some point, this stress can exceed the strength of the material, causing a crack to form. If nothing stops this crack from propagating through the material, it will cause the object's structure to fail. A thermal shock resistant layer can help to prevent or mitigate the impact of the thermal shock, by helping to minimize the impact of thermal stresses created by the expansion of steel at high temperature, on the insulation system.

In one embodiment, the thermally insulating or thermal shock resistant layer is, for example and without limitation, an aerogel blanket (14). The aerogel blanket (14) is positioned on the outer surface of the first pipe (4), while the thermally insulating concrete composition (16) is positioned between the aerogel blanket (14) and the inner surface of the second pipe (6). By positioning the thermally insulating or thermal shock resistant layer between the inner pipe (4) and the thermally insulating concrete composition (16), the amount of thermal stress on the concrete composition (16) can be reduced, which can help prevent cracking of the concrete composition (16). In another embodiment, for example and without limitation, the thermally insulating or thermally shock resistant layer is an alkali resistant fiberglass cloth that can also help prevent bonding between the thermally insulating concrete composition and the steel pipe. In a still further embodiment, and depending upon the design and application requirements, both an aerogel blanket (14) and alkali resistant fiberglass cloth is used.

In a further embodiment in accordance with the invention, a film, such as, for example and without limitation, a low density polyethylene (LDPE) or polyvinylidene chloride (PVDC) film, adhesive tape or fiberglass cloth may be used for wrapping the aerogel blanket (14), for separating the aerogel blanket (14) from the thermally insulating concrete composition (16). The film can help prevent the thermally insulating concrete composition from embedding within the thermally insulating or thermal shock resistant layer, such as, the aerogel blanket (14).

Aerogel blanket (14) used in accordance with the invention is not particularly limited. Aerogel blankets (14) are commercially available, and in one embodiment, combine silica aerogel and fibrous reinforcement that turns the brittle aerogel into a durable, flexible product. The mechanical and thermal properties of the product may be varied based upon the choice of reinforcing fibers, the aerogel matrix and opacification additives included in the composite. Moreover, the type of aerogel blanket (14) used can depend upon the application requirements. An example of a commercially available aerogel blanket includes Pyrogel® XTE.

The thickness of the aerogel blanket (14) used in accordance with the invention is also not particularly limited, so long as it can provide sufficient insulation as required by the application requirements. In one embodiment, for example and without limitation, the aerogel blanket (14) has a thickness of about 5, 10, 15, 20 or 25 mm. In a further embodiment, the thickness of the aerogel blanket layer (14) can be achieved by use of multiple layers to have total layer thickness that can range from about 5 to 50 mm, and any value in between.

In one embodiment, the thermally insulating concrete composition (16) used in accordance with the specification is a low density concrete. Low density concretes are generally known to a skilled worker, and can generally be divided into two groups: cellular concretes and aggregate concretes. Cellular concretes are generally made by incorporating air voids in a cement paste or cement-sand mortar, through use of either preformed or formed-in-place foam. These concretes weigh from 15 (240 kg/m³) to 90 (1441 kg/m³) pounds per cubic foot. While aggregate concretes are made with expanded perlite or vermiculite aggregate or expanded polystyrene pellets. Oven-dry weight typically ranges from 15 (240 kg/m³) to 60 (961 kg/m³) pounds per cubic foot.

In a further embodiment, cellular concretes are made up of Portland or thermal 40 cement, water, foaming agent, and compressed air. The foam is formulated to provide stability and inhibit draining (bleeding) of water. Pozzolans, such as fly ash, fumed silica and fibers are often added to the mix to customize compressive strength, thermal stability and flexural strength.

In another embodiment, the thermally insulating concrete composition (16) used in accordance with the specification contains a thermally stable cement, glass bubbles, porous glass spheres or aerogel, or a combination thereof, and glass fibres. Moreover, the dimension of the thermally insulating concrete composition (16) used is not particularly limited so long as it can achieve the application requirements. In one embodiment, for example and without limitation, the thermally insulating concrete composition (16) has a thickness of about 0.5, 1.0, 2.0 or 3 inches. In a further embodiment, the thickness of the thermally insulating concrete composition (16) can range from about 0.5 to 5 inches, and any value in between.

The type of thermally stable cement used in the thermally insulating concrete composition (16) in accordance with the specification is not particularly limited. Thermally stable cement is stable at high temperatures and does not degrade or deteriorate to such an extent that it would lose the ability to function as cement. In one embodiment, thermally stable cements include, for example and without limitation, high alumina cements, oil-well cements and geo-polymer cements. In a further embodiment, high alumina cements can include, for example and without limitation, calcium-aluminate (Ca—Al) cement. In another embodiment, oil well cements can include, for example and without limitation, Class G cement as per American Petroleum Institute (API) 10A specification. In another embodiment, the Class G cement contains Portland cement and 325 mesh silica flour. In another further embodiment, oil well cements can include, for example and without limitation, Thermal 40 cement.

Cements along with other agents or additives that provide thermal stability to the cement can also be used to prepare the concrete coating composition disclosed herein. In one embodiment, the cement used is, for example and without limitation, Portland cement and the additive used along with the cement is, for example, silica flour. In another embodiment, for example and without limitation, the thermally stable cement is a combination of Portland cement, fly ash and slag. The quantity of the additive used along with the cement is not particularly limited and can be determined by a skilled worker based on the specific application requirements.

The quantity of cement used in the concrete coating is not particularly limited and would depend upon the application requirements and the desired properties of the coating. In one embodiment, for example and without limitation, the amount of cement in the composition ranges from 350 to 550 kg/m³ of the concrete coating composition. In another embodiment, where the cement is present as a paste, the cement has a volume of, for example and without limitation, 25 to 45% total volume of the concrete coating composition.

The glass bubbles as disclosed herein typically are non-porous hollow centered glass microspheres that have a vacuum in the hollow centre, which can result in low thermal conductivity. In addition, these low density glass bubbles can allow for higher filler loading and can help to improve fluidity of the mixture; and can also be chemically and thermally stable. The type of glass bubble used in accordance with the specification is not particularly limited and can include, for example and without limitation, the 3M™ Glass Bubbles that can be commercially available in the K and S series.

The type of glass bubbles selected depends upon the design requirements of the coating composition; as the properties of the glass bubbles can influence the characteristics of the coating. In the concrete coating composition disclosed herein, the size of glass bubbles used is not particularly limited so long as they can provide sufficient concrete properties. In one embodiment, for example and without limitation, the glass bubbles have a size ranging from 60 to 120 microns (μ), and sizes in between. In a further embodiment, the glass bubbles have a size ranging from 75 to 95μ. In a still further embodiment, the glass bubbles have a size ranging from 80 to 85μ.

The glass bubbles as disclosed herein and used in the concrete coating composition can have high strength-to-weight ratio. In one embodiment, the glass bubbles have, for example and without limitation, an isostatic crush strength ranging from 500 to 18,000 psi, and values in between. In a further embodiment, the glass bubbles have an isostatic crush strength ranging from, for example and without limitation, 2,000 to 5,500 psi. In a still further embodiment, the glass bubbles have an isostatic crush strength ranging from, for example and without limitation, 3,000 to 4,000 psi.

As noted above, the glass bubbles used in the concrete coating composition disclosed herein can be low density particles. In one embodiment, for example and without limitation, the density of the glass bubbles can range from about 0.125 to 0.60 g/cc, and values in between. In a further embodiment, the density of the glass bubbles can range from, for example and without limitation, 0.20 to 0.45 g/cc. In a still further embodiment, the density of the glass bubbles can range from, for example and without limitation, 0.35 to 0.38 g/cc.

The quantity of glass bubbles present in the concrete coating composition can depend upon the application requirements of the coating and the desired properties of the coated cement. In one embodiment, for example and without limitation, the glass bubbles range from 1 to 40% volume aggregate (vol agg.), and values in between. In a further embodiment, for example and without limitation, the glass bubbles range from 15 to 30% vol agg.

The porous glass spheres used in the concrete coating composition disclosed herein are not particularly limited. In one embodiment, the porous spheres are produced from recycled glass. They differ from the glass bubbles due to their porous surface and lack of a hollow vacuum centre. Like the glass bubbles, the porous glass spheres can be light weight, pressure resistant and can be chemically and thermally stable. In one embodiment, the type of porous glass sphere used in the coating composition is, for example and without limitation, Poraver™, which can be commercially available.

The size of the porous glass sphere used is also not particularly limited. In one embodiment, for example and without limitation, the glass sphere has a granular size ranging from 0.04 to 4 mm, and values in between. In a further embodiment, the glass sphere has a granular size ranging from 0.25 to 2 mm.

The strength of the glass sphere used is also not particularly limited, so long as it can provide sufficient coating strength, which would depend upon the application requirements. In one embodiment, for example and without limitation, the glass sphere has a crushing resistance of more than 6.5 N/mm². Such values can be present in glass spheres having a smaller size. In another embodiment, for example and without limitation, the glass spheres can have a crushing resistance from about 1.4 to about 6.5 N/mm². In a further embodiment, the glass spheres can have a crushing resistance from, for example and without limitation, 2.6 to 1.4 N/mm².

As noted above, the glass spheres used in the concrete coating composition disclosed herein can have a low density. In one embodiment, for example and without limitation, the glass spheres have a bulk density ranging from 190±20 to about 530±70 kg/m³. In a further embodiment, the glass spheres have a bulk density ranging from, for example and without limitation, 190±20 to 340±30 kg/m³.

The quantity of glass spheres used in the concrete coating composition disclosed herein is not particularly limited and can depend upon the application requirements. In one embodiment, for example and without limitation, the quantity of glass spheres in the concrete coating composition is present in an amount from 50 to nearly 100% vol aggregate (aggr.). The volume aggregate refers to the volume of aggregate in the total volume of the coating composition. In a further embodiment, the concrete coating composition is present in an amount from, for example and without limitation, 70 to 90% vol. aggr.

As noted above, the concrete coating composition further contains glass fibres. It has been found that presence of glass fibres can provide flexibility to the coating and also aid in preventing cracking of the coated concrete. The type and quantity of glass fibres used is not particularly limited. In one embodiment, for example and without limitation, the glass fibre is an alkali-resistant glass fibre, such as Nippon Electric glass. The quantity of such glass fibres can vary and can depend upon the application requirements. In one embodiment, for example and without limitation, glass fibres in the concrete coating composition can be present from about 0 to about 2% vol. total, and values in between. In a further embodiment, the glass fibres are present from, for example and without limitation, 0.1 to 1% vol total. In a still further embodiment, the glass fibres are present from, for example and without limitation, 0.2 to 0.5% vol total.

The length of the glass fibres used in the concrete coating composition is not particularly limited. In one embodiment, the glass fibres are from, for example and without limitation, about ¼″ to about 1″ in length. In a further embodiment, the glass fibres range from, for example and without limitation, ½″ to ¾″ in length. Further, the diameter of the glass fibres can vary depending upon the application requirements. In one embodiment, the glass fibres have a diameter of, for example and without limitation, 0.01 to 0.02 mm.

In preparing the concrete, water is generally added to the concrete coating composition. The amount of water added to the composition can depend upon the application requirements of the coated concrete. In one embodiment, for example and without limitation the water to cement (w/c) or water to binder (w/b) ratio ranges from, 0.22 to 0.8. In a further embodiment, the water to cement (w/c) or water to binder (w/b) ratio ranges from, for example and without limitation, about 0.3 to about 0.5.

The concrete coating composition disclosed herein can have additional components depending upon the application requirements of the coated concrete. For example, in one embodiment, it has been found that aerogel can be added to the concrete, such as, for example and without limitation, to cement, to provide further thermal insulation. The aerogel can substitute the porous glass spheres or be present in combination with the glass spheres.

Further to the above, the concrete coating composition can be provided with admixtures that can affect the properties of the concrete coating composition. The amount and type of admixtures used are not particularly limited and can depend upon the application requirements. In one embodiment, for example and without limitation, admixtures can include one or more of air entrainers, super plasticizers and viscosity modifiers.

Example of an air entrainer can include, for example and without limitation, Darex® AEA ED, which can be commercially available. A super-plasticizer as used in the concrete composition, disclosed herein, is formulated to provide higher fluidity for processing. In one embodiment, for example and without limitation, the super-plasticizer used in the concrete composition, disclosed herein, is ADVA® CAST 575, which can be commercially available. The viscosity modifier as used in the concrete composition, disclosed herein, can modify the rheology of the concrete and can allow the concrete to flow without segregation. In one embodiment, for example and without limitation, the viscosity modifier is V-MAR® 3, which can be commercially available.

The quantity of each admixture used is not particularly limited and can depend upon the application requirements of the concrete. In one embodiment, for example and without limitation, each admixture is present from 0 to 5000 mls/100 kg of cement, including values in between. In a further embodiment, for example and without limitation, the admixture is present from about 200 to about 2000 mls/100 kg of cement.

In preparing the coated concrete, the components of the compositions, along with other additives are mixed with water to obtain a consistent mixture, which is then applied to the material to be coated. In one embodiment, for example and without limitation, the material to be coated is a pipe that can be used in downhole steam injection and production operations.

The properties of the coated concrete can vary depending upon the constituents of the composition, the thickness of the coating and the application requirements. In one embodiment, the coating applied to the material has a thickness, for example and without limitation, from about 0.5″ to about 2″, and each value or range in between. In a further embodiment, the coated concrete has a thickness of, for example and without limitation, 0.75″ to 1.25″, and each value or range in between.

The compressive strength of the coated concrete can vary and can depend upon the components and application requirements. In one embodiment, for example and without limitation, the concrete coating, as described above, has a compressive strength measured at 28 days from curing of from 6 to 30 MPa, and values in between. In a further embodiment, the concrete coating has a compressive strength measured at 28 days from curing of from, for example and without limitation, 8 to 20 MPa.

The thermal conductivity (K-factor) of the coated concrete obtained from the composition, disclosed herein, can vary depending upon the constituents of the composition. The K-factor is a measure of the number of watts conducted per meter per Kelvin. In one embodiment, the K-factor of the coated concrete produced in accordance with the specification (as described above) is, for example and without limitation, from 0.09 to 0.26 W/mK when measured at 100° C.

The density of the concrete coating obtained from the composition, as described above, can vary depending upon the constituents of the composition and different densities can be obtained depending upon the application requirements. In one embodiment, for example and without limitation, the fresh density of the coated concrete (as described above) can range from 300 to 1200 Kg/m³. In a further embodiment, the theoretical fresh density of the coated concrete (as described above) is, for example and without limitation, from 300 to 950 Kg/m³.

In another embodiment, as noted herein, the thermally insulating concrete composition (16) can include a cellular concrete, such as, a foam concrete. Cellular, or foam concrete, can contain 50-90% air embedded in the cement paste. Such cellular or foam concretes can also be considered as light weight concretes, where densities as low as 300 kg/m³ can be developed with the use of foaming agents. Moreover, such concretes can serve as good insulating materials. In addition, the use of such concretes can help eliminate the usage of multiple light weight aggregates, simplifying the batching and coating process. Furthermore, the air bubbles can help improve rheology of the fresh mix and act as a pumping aid.

The type and amount of cement used in the foam concrete disclosed herein, is not particularly limited and can depend upon the application requirements. In one embodiment, for example and without limitation, the cement used is a blend of Portland cement with fly ash and silica fume, or Thermal 40 cement. In a particular embodiment, for example and without limitation, the cement used is Portland cement blend with fly ash and silica fume.

The amount of cement used is not particularly limited and can depend upon the application and design requirements. In one embodiment, for example and without limitation, the amount of cement is in a foam concrete can range from 400 to 440 kg/m³. In another embodiment, for example and without limitation, the cement used ranged from 60 to 75% of the total mix by mass, or from 10 to 20% of the total mix by volume.

The type and amount of foaming agent used in the foam concrete disclosed herein is not particularly limited and can depend upon the design and application requirements. In general, commercially available foaming agents that are known to a person of skill in the art can be used to form the foam concrete. In one embodiment, for example and without limitation, the foaming agent is Stable Air® available from CC Technologies. In addition, in one embodiment, the amount of foaming agent used, for example and without limitation, is 40 to 80% (and values in between) by volume of the concrete mix design. In a further embodiment, the foaming agent is a commercially available product which meets ASTM C869 and ASTM C796 requirements.

In forming the foam concrete noted herein, further additives and aggregates can be added. The amount and type of additives and aggregates are not particularly limited and can depend upon the application requirements. In addition, typical additives and aggregates as are known to a person of skill in the art can be used in preparation of the foam concrete.

The foam concrete disclosed herein have dry density, compressive strength and thermal conductivity (K-factor), which are not particularly limited and can depend upon the application requirements. In one embodiment, for example and without limitation, the foam concrete disclosed herein has a dry density range from 200 to 600 kg/m³. In another embodiment, for example and without limitation, the foam concrete disclosed herein has a compressive strength from 1 to 4 MPa. In a further embodiment, for example and without limitation, the foam concrete disclosed herein has a K-factor from about 0.09 to 0.16 W/mK, as typically measured using ISO 22007-2:2008, ISO 8301 and ASTM C518.

In preparing the foam concrete, water is generally added to the concrete coating composition. The amount of water added to the composition can depend upon the application requirements of the coated concrete. In one embodiment, for example and without limitation, the water to cement (w/c) or water to binder (w/b) ratio ranges from, 0.22 to 0.4. In a further embodiment, the water to cement (w/c) or water to binder (w/b) ratio is, for example and without limitation, about 0.3.

The tubular (2) disclosed herein can be coupled to other tubulars using couplers (20) that should be known to a person of ordinary skill in the art. In one embodiment, for example and without limitation, the ends of the outer surface of the second pipe (6) are threaded. A coupler (20), as typically used, is a small tubular piece that is threaded on the inside surface to allow connecting two pipes together and enable fluid to flow from one pipe to another pipe via the coupler (20).

As noted herein, in another aspect, the specification discloses a process for manufacturing a thermally insulated tubular (2), as disclosed herein. In one embodiment in accordance with the specification, the process involves wrapping the first pipe (4) with an aerogel blanket (14) or fibre glass cloth. The method of wrapping the aerogel blanket (14) to the outer surface of the first pipe (14) is not particularly limited. In one embodiment, for example and without limitation, the aerogel blanket (14) is wrapped around the outer surface of the first pipe (4). In a further embodiment, for example and without limitation, the aerogel blanket (14) can be affixed in place by use of a thermally resilient or resistant tape. In addition, a polymeric film (such as LDPE, PVDC or the like) can be used to wrap over the aerogel blanket (14) to retain the aerogel blanket (14) in place on the outer surface of the first pipe (4). The thermally resilient or resistant tape and the polymeric film used are not particularly limited, and various options are commercially available.

Once the aerogel blanket (14) is wrapped on the outer surface of the first pipe (4), the first pipe (4) can be positioned within the conduit of the second pipe (6) ensuring that the outer surface of the first pipe (4) is spaced apart from the inner surface of the second pipe (6). As disclosed herein, various methods can be used to ensure that the space between the outer surface of the first pipe (4) and the inner surface of the second pipe (6) is maintained to form the annulus (10) of the tubular (2).

Upon positioning the first pipe (4) within the second pipe (6), the thermally insulating concrete composition can be poured or injected into the annulus (10) to form the tubular (2) in accordance with the specification. The method of pouring or injecting the thermally insulating concrete composition is not particularly limited, so long as the concrete does not solidify and voids are prevented from being formed within the annulus (10).

The tubular (2) disclosed herein can then be used in a process for extracting hydrocarbons, injection of steam, transportation of hydrocarbons and other applications as should be known to a person of skill in the art.

### EXAMPLES

The specification is provided with the following illustrative examples to assist in the understanding of the concrete coating composition and the coated pipe, disclosed herein. The examples are intended to aid in the understanding of the embodiments disclosed, and are not intended to limit the scope of protection.

### Example 1

### Transient Plane Source-TPS 2500S (ISO/DIS 22007-2.2): Thermal Conductivity, Heat Capacity and Thermal Diffusivity

The objective of this testing was to measure thermal conductivity (W/mK), specific heat capacity (J/kg K) and thermal diffusivity (mm²/s) of the concrete at various temperatures (20, 100 and 250° C.). The samples were prepared and tested as per the guidelines provided in ISO 22007-2:2008, ISO 8301 and ASTM C518 standards.

### Example 2

### Shear/Push Off Strength Test Procedure

This method was developed to determine the strength of the bond between the concrete coating system and the steel pipe or tubular. This parameter is can be considered for pipe handling and installation of insulated coated pipe/tubulars in the field.

Sections of coated pipes approximately 30 cm in length were cut and 10 cm lengths of the coating removed at both ends. A force via a piston is applied directly onto the steel pipe, with the coating being supported on the other end by a steel plate. The maximum force required to dislodge the steel pipe from the coating is used to calculate the shear/push off. The shear strength is calculated by dividing the maximum force by the surface area along the outer diameter of the pipe.

### Example 3

### Coefficient of Thermal Expansion Via Dynamic Mechanical Analysis

The objective was to determine the coefficient of thermal expansion (CTE) of the concrete via Dynamic Mechanical Analysis using TA Instruments ARES Rheometer. This can also be done via TMA using TA Instruments Q400.

The instrument was set to run in torsion rectangular mode. An aluminum standard was used to obtain calibration factor (calibration factor=actual CTE/observed CTE). A sample approximately 1 mm thick×12.5 mm width×43 mm length) was affixed to grips with a 25 mm gap separation. The sample was heated at 2° C./min from 30° C. to 200° C., using 0.01% strain at 1 radian/s. The calibration factor was applied to the change in length data (ΔL) and the data plot versus temperature. The slope of the plotted line was obtained in the region of interest using Orchestrator software and CTE determined.

### Example 4

### Cyclic Heat Aging Test Procedure

This method was developed to investigate the effect of exposure to cycles of hot and cold on concrete coating. This experiment will be carried out on laboratory specimens in an oven. The concrete specimens will be observed for physical defects and tested for compressive strength to determine if any degradation occurs.

5 cm cube specimens was cast demoulded and cured in the moisture room for 7 days. Some specimens were tested for compressive strength as the reference before the exposure to heat cycling. Remaining cubes were transferred to the oven at maintained at 230° C. and left for 24 hours. After 24 hours the oven was shut off and specimens allowed to cool for another 24 hours: this represents 1 heating and cooling cycle. 3 cubes were selected and tested for compressive strength after the first cycle. This was repeated for subsequent cycles with the remaining cubes until all specimens were tested, with the last set being exposed to the maximum number of cycles.

### Example 5

### Concrete Mixing Procedure

This procedure describes the sequence of additions of materials used to make the specified concrete and to obtain the best possible outcomes of the desired fresh properties like rheology and pumpability.

To ensure best possible results, the internal surface of the mixer/mixing bowl should be slightly moistened.

1. First, the lightweight aggregates (Poraver, 3M glass bubbles) are added along with the proportioned amount of mix water and air entrainment admixture if necessary. This is mixed in high shearing planetary type mixer for 3 minutes.

2. Next, the proportioned amount of cement is added to the mixture and further mixing is done for another 5 minutes.

3. Then, the volume of admixtures (superplasticizers, viscosity modifiers) is added to the mixture and mixing if continued for another 5 minutes.

4. Next, the mass of fibers required are introduced and the mixture mixed for 2 minutes.

5. A visual check is made to observe whether clumping of the fibers is present. If this is so, additional mixing for another 3 minutes is required. Otherwise the concrete is suitable for QC tests (slump flow) and ready for pumping or casting.

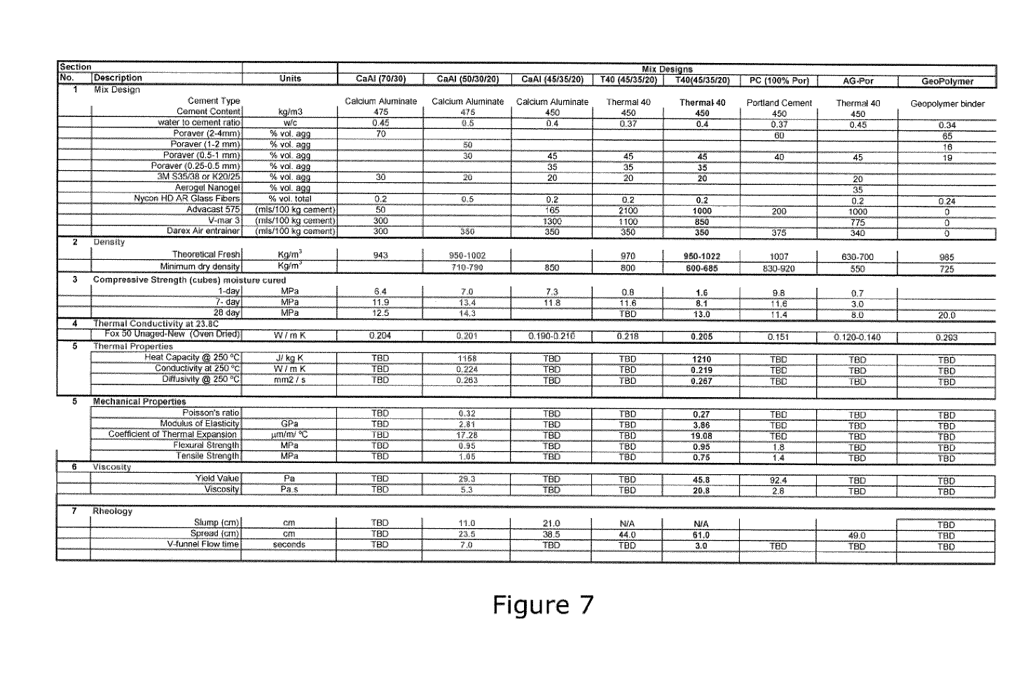

Using the methods described herein and those known in the art, a number of concrete coating compositions have been prepared. FIG. 7 discloses a table containing summary of some of the compositions prepared and their properties.

Foam Concretes

Experimental details noted below relate to the formation of foam concretes used in the thermally insulated tubulars, disclosed herein. The M100 Aerator available from CCT technology and the foaming agent (CCT Stable Air® Foaming Agent) available from them was used for forming foams and aeration.

### Example 6

### Mix Design Development

Concrete mix designs were developed with amounts of foam ranging from 48 to 77% by volume, also including insulating aggregates such as Aerogel and Poraver from 0 to 20%.

A Portland cement blend with fly ash & silica fume was used as a binder because of the prolonged curing time (7 days) with Thermal 40 cement and foam mix designs. These mixtures had dry densities of ranging from 416 to 572 kg/m³, compressive strength varying from 0.96 to 2.92 MPa and thermal conductivity values typically ranging from 0.09 to 0.13 W/mK.

The choice of using an altered Thermal 40 cement (NT40) blend, which has shorter curing time and the addition of fibre reinforcement to negate the chances of cracking due to thermal stresses when heated resulted in dry densities of ranging from 430 to 522 kg/m³, compressive strength varying from 1.42 to 1.68 MPa and thermal conductivity values ranging from 0.123 to 0.129 W/mK.

The use of foam as principal constituent of the concrete improved the fluidity of the concrete, which required a lower water to cement ratio to attain a pumpable consistency. A specific mixing sequence and time for each step was designed to ensure consistent and stable concrete is produced on a laboratory and plant scale.

A summary of these results are depicted in Table 2.

| | | | Foam | Concrete | Density of | Concrete | | Dry | Compressive | |
|---|---|---|---|---|---|---|---|---|---|---|
| Cement | Cement | w/c | Volume | Target Density | Foam | Fresh Density | Comments & | Density | Strength | K-factor |
| Type | Content | ratio | (%) | (kg/m3) | (kg/m3) | (kg/m3) | Observations | (kg/m3) | (MPa) | (W/mK) |
| PC/FA/SF | 425 | 0.34 | 70.0 | 619 | 63 | 572 | | 416 | 1.66 | 0.100 |
| PC/FA/SF | 400 | 0.35 | 51.0 | 598 | 64 | 597 | 20% Aerogel | 456 | 0.96 | 0.092 |
| PC/FA/SF | 410 | 0.35 | 61.0 | 587 | 61 | 592 | 10% Aerogel | 438 | 1.35 | 0.095 |
| PC/FA/SF | 490 | 0.34 | 55.0 | 753 | 58 | 737 | 10% Poraver | 530 | 1.52 | 0.122 |
| PC/FA/SF | 450 | 0.34 | 48.0 | 740 | 61 | 735 | 20% Poraver | 572 | 2.92 | 0.130 |
| NT40/SF | 425 | 0.34 | 71.0 | 629 | 63 | 599 | Fiber Content -0.4% | 430 | 1.68 | 0.123 |
| NT40/SF | 420 | 0.34 | 61.0 | 625 | 64 | 624 | Fiber Content - 0.4%, | 454 | 1.42 | 0.126 |
| | | | | | | | 10% Aerogel | | | |
| NT40/SF | 420 | 0.34 | 51.0 | 625 | 64 | 645 | Fiber Content - 0.4%, | 522 | 1.51 | 0.129 |
| | | | | | | | 20% Aerogel | | | |

Mix designs, 71% foam, 60% foam with 10% Aerogel and 50% foam with 20% Aerogel were used to cast a 1.25″ thick coating on 4.5″ diameter pipe section wrapped with fiberglass cloth. The section was heated to 230° C. and the coating monitored for severe cracking. Mix designs with 0.4% fibre reinforcement performed well under the pipe section heating test.

### Example 7

### Testing

A 10 ft (10″ pipe with 8″ OD liner pipe) long pipe section was cast using 53% foam with 20% Aerogel concrete mix design. No aerogel blanket or fiberglass cloth was used as thermal barrier layer. This pipe section was internally heated to a steel pipe temperature of 230° C.

Table 3 below shows temperature readings from the pipe section heating test. There was a spike in the average temperature recorded on the surface of the pipe, 94° C., around 1.5 hours into the test. Moisture was observed being driven off from the concrete coating and then some radial cracks followed after the surface temperature had stabilized. After 69 hours the test was terminated because the surface temperature seemed constant at 68° C.

TABLE 3
Temperature readings from pipe section heating test

| | | | | | Average | |
|---|---|---|---|---|---|---|
| | | | Elapsed | Internal | External | |
| | | | Time | Temperature | Temperature | |
| Date | Time | | (hrs) | (° C.) | (° C.) | |
| 31-Mar | 11:13 | AM | 0.00 | 22 | 22 | |
| | 11:42 | AM | 0.48 | 139 | 41 | |
| | 12:41 | PM | 1.47 | 232 | 94 | * |
| | 3:14 | PM | 4.02 | 232 | 89 | |
| 01-Apr | 8:45 | AM | 21.54 | 232 | 74 | |
| | 11:45 | AM | 24.54 | 232 | 73 | |
| | 3:25 | PM | 28.21 | 232 | 73 | |
| 02-Apr | 1:00 | PM | 49.79 | 232 | 71 | |
| 03-Apr | 8:23 | AM | 69.17 | 232 | 68 | |

Notes:
1. 10″ ID coating on 8″ OD steel pipe (1.0″ coating)
2. Coating consists of 1″ thick foam concrete (50F20 AG Mix)
3. * Pipe cracking occurs, water vapour being driven off

### Example 8

### Void Analysis

Analysis of void content and porosity of insulation concrete samples revealed that foam concrete mixes had significantly higher percentage of voids. Values obtained from gas Pycnometer indicated an average of 85% porosity on foam concrete samples compared to 49% porosity on Poraver/S35 current HT-ThermoShield concrete.

TABLE 4
Porosity of concrete samples tested using gas Pycnometer

| | Dry Density | Porosity |
|---|---|---|
| Mix Design | (kg/m3) | (%) |
| Poraver/S35 | 838 | 49.0 |
| 71% Foam | 402 | 86.4 |
| 60% Foam 10% Aerogel | 455 | 84.9 |

### EMBODIMENTS

1. A thermally insulated tubular comprising:
a first pipe having a first pipe diameter and a second pipe having a second pipe diameter, the second pipe diameter being greater than the first pipe diameter, the first pipe positioned along a conduit of the second pipe and spaced-apart from an interior surface of the first pipe; and
a thermally insulating composition coupling the first pipe to the second pipe and positioned in an annulus formed by the first and second pipe, the thermally insulating composition comprising:
a thermally insulating or thermal shock resistant layer coupled to an exterior surface of the first pipe; and
a thermally insulating concrete composition coupled to the thermally insulating or thermal shock resistant layer and to the interior surface of the second pipe.

2. The thermally insulated tubular according to embodiment 1, wherein the thermally insulating or thermal shock resistant layer is an aerogel blanket or fibre glass cloth.

3. The thermally insulated tubular according to embodiment 1 or 2, further comprising tabs extending from the exterior surface of the first pipe for spacing apart the first pipe from the second pipe.

4. The thermally insulated tubular according to any one of embodiments 1 to 3, further comprising a polymeric film between the aerogel blanket and the thermally insulating concrete composition.

5. The thermally insulated tubular according to embodiment 4, wherein the polymeric film is concentrically wound around the aerogel blanket.

6. The thermally insulated tubular according to any one of embodiments 1 to 5, wherein the second pipe is longer than the first pipe, and with the first pipe positioned within the ends of the second pipe.

7. The thermally insulated tubular according to any one of embodiments 1 to 6, wherein the thermally insulating concrete composition comprises:
a thermally stable cement;
   glass bubbles;
   porous glass spheres or aerogel, or a combination thereof; and
glass fibres.

8. The thermally insulated tubular according to any one of embodiments 1 to 7, wherein the thermally stable cement comprises oil well cement, high alumina cement, geopolymer cement or Portland cement blended with fly ash and slag.

9. The thermally insulated tubular according to any one of embodiments 1 to 8, wherein the thermally stable cement is Portland cement, and further comprising an additive.

10. The thermally insulating tubular according to embodiment 9, wherein the additive is silica flour.

11. The thermally insulated tubular according to any one of embodiments 1 to 10, wherein the cement content ranges from 350 to 550 kg/m³.

12. The thermally insulated tubular according to any one of embodiments 1 to 10, wherein the cement is present as a paste and having a volume of 25 to 45%.

13. The thermally insulated tubular according to any one of embodiments 1 to 12, wherein the glass bubbles comprises 3M glass bubbles.

14. The thermally insulating tubular according to embodiment 13, wherein the 3M® glass bubbles have a size ranging from 75 to 177 microns.

15. The thermally insulated tubular according to any one of embodiments 1 to 14, wherein the glass bubbles have an isostatic crush strength ranging from 500 to 5,500 psi.

16. The thermally insulated tubular according to any one of embodiments 1 to 15, wherein the glass bubbles have a true density ranging from 0.20 to 0.45 g/cc.

17. The thermally insulated tubular according to any one of embodiments 1 to 16, wherein glass bubbles are present in a range from 0 to 30% vol agg.

18. The thermally insulated tubular according to any one of embodiments 1 to 17, wherein porous glass spheres comprises Poraver® glass spheres.

19. The thermally insulated tubular according to any one of embodiments 1 to 18, wherein the porous glass spheres are present in a range from 70 to 90% vol. agg.

20. The thermally insulated tubular according to any one of embodiments 1 to 19, wherein the glass fibres have a length from about ¼″ to about 1″ in length.

21. The thermally insulated tubular according to embodiment 20, wherein the glass fibres diameter range in size from 0.01 to 0.02 mm.

22. The thermally insulated tubular according to embodiment 20 or 21, wherein the glass fibres are alkali resistant glass fibres.

23. The thermally insulated tubular according to any one of embodiments 20 to 22, wherein the glass fibres are present in a range from 0.1 to 1% vol. total.

24. The thermally insulated tubular according to any one of embodiments 1 to 23, further comprising water.

25. The thermally insulated tubular according to embodiment 24, wherein the water to cement ratio ranges from 0.2 to 0.6.

26. The thermally insulated tubular according to embodiment 24, wherein the water to binder ratio ranges from 0.2 to 0.6.

27. The thermally insulated tubular according to any one of embodiments 1 to 26, further comprising one or more admixtures.

28. The thermally insulated tubular according to embodiment 27, wherein the one or more admixtures comprise air entrainer, super plasticizer and/or viscosity modifier.

29. The thermally insulated tubular according to embodiment 27 or 28, wherein the one or more admixtures are present in amount ranging from 5 to 3000 mls/100 kg cement.

30. The thermally insulated tubular according to any one of embodiments 1 to 29, wherein the concrete coating composition has compressive strength measured at 28 days ranging from 1 to 20 MPa.

31. The thermally insulated tubular according to any one of embodiments 1 to 30, wherein the concrete coating composition has a K-factor ranging from 0.08 to 0.28 W/mK at 100° C.

32. The thermally insulated tubular according to any one of embodiments 1 to 31, wherein the concrete coating composition has a fresh density ranging from 300 to 1000 Kg/m³.

33. The thermally insulated tubular according to any one of embodiments 1 to 32, wherein the tubular is structurally stable and provides thermal insulation for use up to at least 305° C.

34. The thermally insulated tubular according to any one of embodiments 1 to 6, wherein the thermally insulating concrete composition is a light weight concrete composition having 10 to 70% void or air content.

35. The thermally insulated tubular according to any one of embodiments 1 to 34, wherein the thermally insulating concrete composition is structurally stable and provides thermal insulation for use up to at least 350° C.

36. The thermally insulated tubular according to any one of embodiments 1 to 6, wherein the thermally insulating concrete composition comprises a foam concrete.

37. The thermally insulated tubular according to embodiment 36, wherein the foam concrete has a dry density range from 200 to 600 kg/m³.

38. The thermally insulated tubular according to embodiment 36 or 37, wherein the foam concrete has a compressive strength from 0.8 to 4 MPa measured at 28 days.

39. The thermally insulated tubular according to any one of embodiments 36 to 38, wherein the foam concrete disclosed herein has a thermal conductivity (K-factor) from about 0.09 to 0.16 W/mK.

40. A process for manufacturing a thermally insulated tubular, the process comprising the steps of:
coupling a thermally insulating or shock resistant blanket to an exterior surface of a first pipe;
positioning the first pipe with the thermally insulating or shock resistant blanket along a conduit of a second pipe, the exterior surface of the first pipe being spaced apart from the interior surface of the second pipe; and
injecting a thermally insulating concrete composition in the annulus formed between the exterior surface of the first pipe and the interior surface of the second pipe.

41. The process according to embodiment 40, further comprising wrapping the thermally insulating or shock resistant blanket with a polymeric film before positioning the first pipe within the second pipe.

42. The process according to embodiment 40 or 41, wherein the thermally insulating or shock resistant blanket is an aerogel blanket.

43. The process according to embodiment 40 or 41, wherein the thermally insulating or shock resistant blanket is an alkali resistant fiberglass cloth.

44. A process for extracting hydrocarbon, comprising use of the thermally insulated tubular as defined in any one of embodiments 1 to 40.

Certain adaptations and modifications of the described embodiments can be made. Therefore, the above discussed embodiments are considered to be illustrative and not restrictive.

### PARTS LIST

2 tubular
4 first hollow pipe (inner pipe)
6 second hollow pipe (outer pipe)
8 conduit
10 annulus
12 thermally insulating composition
14 aerogel blanket
16 thermally insulating concrete composition
18 polymeric film
20 coupler
22 centralizers/tabs

1. A thermally insulated tubular comprising:
a first pipe having a first pipe diameter and a second pipe having a second pipe diameter, the second pipe diameter being greater than the first pipe diameter, the first pipe positioned along a conduit of the second pipe and spaced-apart from an interior surface of the first pipe; and
a thermally insulating composition coupling the first pipe to the second pipe and positioned in an annulus formed by the first and second pipe, the thermally insulating composition comprising:
a thermally insulating or thermal shock resistant layer coupled to an exterior surface of the first pipe; and
a thermally insulating concrete composition coupled to the thermally insulating or shock resistant blanket and to the interior surface of the second pipe.

2. The thermally insulated tubular according to claim 1, wherein the thermally insulating or thermal shock resistant layer is an aerogel blanket or an alkali-resistant fibreglass cloth.

3. The thermally insulated tubular according to claim 1, further comprising tabs extending from the exterior surface of the first pipe for spacing apart the first pipe from the second pipe.

4. The thermally insulated tubular according to claim 1, further comprising a polymeric film between the aerogel blanket and the thermally insulating concrete composition.

5. The thermally insulated tubular according to claim 4, wherein the polymeric film is concentrically wound around the aerogel blanket.

6. The thermally insulated tubular according to claim 1, wherein the second pipe is longer than the first pipe, and with the first pipe positioned within the ends of the second pipe.

7. The thermally insulated tubular according to claim 1, wherein the thermally insulating concrete composition comprises:
a thermally stable cement;
glass bubbles;
porous glass spheres or aerogel, or a combination thereof; and
glass fibres.

8. The thermally insulated tubular according to claim 7, wherein the thermally stable cement comprises oil well cement, high alumina cement, geopolymer cement or Portland cement blended with fly ash and slag.

9. The thermally insulated tubular according to claim 7, wherein the thermally stable cement is Portland cement, and further comprising an additive, and wherein optionally, the additive is silica flour.

10. (canceled)

11. The thermally insulated tubular according to claim 7, wherein:
the cement content ranges from 350 to 550 kg/m³ or the cement is present as a paste and having a volume of 25 to 45%, and/or
the glass bubbles have an isostatic crush strength ranging from 500 to 5,500 psi and/or the hollow glass bubbles comprises 3M® glass bubbles, optionally having a size ranging from 75 to 177 microns and/or an isostatic crush strength ranging from 500 to 5,500 psi and/or the glass bubbles have a true density ranging from 0.20 to 0.45 g/cc and/or the glass bubbles are present in a range from 0 to 30% vol agg, and/or
wherein the porous glass spheres comprises Poraver® glass spheres, and/or the porous glass spheres are present in a range from 70 to 90% vol. agg, and/or
the glass fibres are alkali resistant glass fibres and/or the glass fibres have a length from about ¼″ to about 1″ in length and/or the glass fibres diameter range in size from 0.01 to 0.02 mm and/or the glass fibres are present in a range from 0.1 to 1% vol. total.

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. The thermally insulated tubular according to claim 1, wherein the concrete coating composition has:
compressive strength measured at 28 days ranging from 6 to 30 MPa, and/or
a K-factor ranging from 0.09 to 0.22 w/mK, when measured at 100° C., and/or
the concrete coating composition has a fresh density ranging from 300 to 1000 Kg/m³, and/or
the tubular is structurally stable and provides thermal insulation for use up to at least 300° C.

31. (canceled)

32. (canceled)

33. (canceled)

34. The thermally insulated tubular according to claim 1, wherein the thermally insulating concrete composition is a light weight concrete composition having 10 to 80% void or air content.

35. The thermally insulated tubular according to claim 1, wherein the thermally insulating concrete composition is structurally stable and provides thermal insulation for use up to at least 300° C.

36. The thermally insulated tubular according to claim 1, wherein the thermally insulating concrete composition comprises a foam concrete.

37. The thermally insulated tubular according to claim 36, wherein the foam concrete has:
a dry density range from 200 to 600 kg/m³ and/or
has a compressive strength from 0.8 to 4 MPa, and/or
has a K-factor from about 0.09 to 0.16 W/mK.

38. (canceled)

39. (canceled)

40. A process for manufacturing a thermally insulated tubular, the process comprising the steps of:
coupling a thermally insulating or shock resistant blanket to an exterior surface of a first pipe;
positioning the first pipe with the thermally insulating or shock resistant blanket along a conduit of a second pipe, the exterior surface of the first pipe being spaced apart from the interior surface of the second pipe; and
injecting a thermally insulating concrete composition in the annulus formed between the exterior surface of the first pipe and the interior surface of the second pipe.

41. The process according to claim 40, further comprising wrapping the thermally insulating or shock resistant blanket with a polymeric film before positioning the first pipe within the second pipe.

42. The process according to claim 40, wherein the thermally insulating or shock resistant blanket is an aerogel blanket.

43. The process according to claim 40, wherein the thermally insulating or shock resistant blanket is an alkali resistant fiberglass cloth.

44. A process for injecting steam or extracting hydrocarbon, comprising use of the thermally insulated tubular as defined in claim 1.
